(19) United States
(12) Patent Application Publication
(10) Pub. No.: US 2011/0097578 A1
(43) Pub. Date: Apr. 28, 2011

(54) Label

(76) Inventor: Susan Frances Matthews, Brisbane (AU)

(21) Appl. No.: 12/912,789

(22) Filed: Oct. 27, 2010

(30) Foreign Application Priority Data
Oct. 27, 2009 (AU) 2009905253

(51) Int. Cl. B32B 5/00

(52) U.S. Cl. 428/343

(57) ABSTRACT

A removable label having a first face adapted for attachment to a support and a second face comprising a reusable writing surface.

### FIELD OF THE INVENTION

The present invention relates to a label. In particular, the present invention relates to a removable label having a surface similar or identical to that of a whiteboard or dry-erase board.

### BACKGROUND ART

Decorative labels that are adapted for attachment to surfaces such as doors, walls and the like have long been known. For instance, decorative labels of this type have been used to decorate children's bedrooms and the like.

However, conventional labels suffer from the drawback that they can become so strongly adhered to the surface after even a relatively short period of time that, upon removal, damage to the surface occurs. This damage can be unsightly, as well as being potentially difficult and costly to repair. In addition, the removal of conventional labels often leaves a sticky or dirty residue on the surface which may be difficult to remove without causing additional damage to the surface.

Further, conventional labels are typically provided with an outwardly facing surface on which is provided a pattern, picture or the like. While it may be possible to write or draw on this surface, any marks made on the surface are typically permanent, meaning that reusing the label is not possible.

Thus, there would be an advantage if it were possible to provide a label that could be removed from the surface to which it is attached without causing any damage to the surface or leaving behind a residue.

Further, there would be an advantage if it were possible to provide a removable label having a surface that could be written or drawn on repeatedly.

It will be clearly understood that, if a prior art publication is referred to herein, this reference does not constitute an admission that the publication forms part of the common general knowledge in the art in Australia or in any other country.

Throughout this specification, the term “comprising” and its grammatical equivalents shall be taken to have an inclusive meaning unless the context of use indicates otherwise.

### OBJECT OF THE INVENTION

In a first aspect, the invention resides broadly in a removable label having a first face adapted for attachment to a support, and removal therefrom without causing damage to the support, and a second face having a reusable writing surface.

Any suitable reusable writing surface may be provided on the second face of the removable label. However, in a preferred embodiment of the invention, the reusable writing surface is of the kind that allows any writing or drawing on the writing surface to be erased so that the writing surface may be reused. It is envisaged that the integrity of the reusable writing surface will be substantially unaffected by repeated erasing of writing or drawings on the writing surface.

In some embodiments of the invention, the reusable writing surface may comprise a whiteboard surface (or dry-erase surface). It will be understood that the term “whiteboard” used herein is not restricted to a conventional whiteboard, but may encompass any surface on which marks made by a non-permanent marking pen may be at least substantially erased so that the surface may be reused.

In some embodiments of the invention, the reusable writing surface may cover a portion of the second face. In other embodiments of the invention, the reusable writing surface may cover substantially the entire second face.

Preferably, the reusable writing surface is adhered or bonded to the second face, although in alternative embodiments of the invention, the second face and the reusable writing surface may be formed as one integral layer. In other embodiments, the second face may comprise a layer laid over the top of the reusable writing surface and provided with, for instance, a cut-out portion that provides a user with access to the reusable writing surface positioned underneath the layer.

In a preferred embodiment of the invention the second face may comprise a plurality of layers. In one embodiment of the invention, the second face may comprise a base layer and an overlay layer on top of the base layer. The overlay layer may be applied to the base layer using any suitable technique. For instance, the overlay layer may be adhered to the base layer using adhesives or fasteners, may be chemically or thermally bonded to the base layer, or may even be printed, sprayed, brushed or the like onto the base layer. In some embodiments of the invention, the overlay layer is a chemical layer printed onto the surface of the base layer using any suitable printing technique such as, but not limited to, offset printing.

In this embodiment of the invention, the overlay layer may comprise the reusable writing surface. In this embodiment of the invention, the overlay layer may comprise any suitable material that may provide a reusable writing surface, such as, but not limited to, whiteboard vinyl.

In an alternative embodiment, the second face may comprise a base layer, an overlay layer and an upper layer located on top of the overlay layer. In this embodiment of the invention, the overlay layer may be of any suitable form, although it is preferred that the overlay layer is provided as a substantially opaque layer. The upper layer may be of any suitable form. However, it is preferred that the upper layer is provided over at least the overlay layer, although the upper layer may extend to cover the entire second face of the label if the overlay layer does not extend to all edges of the label.

In a preferred embodiment, the upper layer may be transparent or semi-transparent, so that the overlay layer is at least partially visible through the upper layer. In this embodiment of the invention, the purpose of the upper layer may be to provide a seal and/or a glossy or shiny layer over the overlay layer. Thus, in this embodiment it is the upper layer that becomes the reusable writing surface, although due to the fact that the upper layer may be transparent or semi-transparent, it is envisaged that any writing will be visible due to a colour contrast between the overlay layer and the upper layer.

The upper layer may be fabricated from any suitable material. For instance, the upper layer may be a polymer layer. Any suitable polymer may be used, and a skilled addressee would understand the types of polymer layers that would provide a suitable finish for the label as a reusable writing surface.

As previously mentioned, the overlay layer may be provided as a substantially opaque layer. The overlay layer may be of any suitable colour, and a skilled addressee will understand that although the reusable writing surface has been described as being similar to a whiteboard surface, the overlay layer does not need to restricted to being white in colour. Any colour may be used, and it is envisaged that different colours may be used for different applications. For instance, for labels to be used by a female child, the overlay layer may be pink, and for those to be used by a male child, the overlay layer may be blue.

The base layer may be fabricated from any suitable material. Preferably, however, the base layer is fabricated from a material having properties that enable the overlay layer (and upper layer when present) to be adhered to the base layer. In addition, it is envisaged that the opposite side of the base layer to that on which the overlay layer is provided may constitute the first face of the label. Thus, the base layer may require properties that provide for either direct attachment to a support, or the application of an attachment layer to the base layer to form the first face.

In some embodiment of the invention, the base layer may be PVC or vinyl. The PVC or vinyl base layer may be provided with an attachment layer, such as an adhesive layer or a magnetic layer that facilitates attachment of the label to a support. In some embodiments of the invention, the PVC or vinyl base layer may be self-adhesive.

Alternatively, the base layer may be fabricated from pearlised paper, and, preferably, from a self-adhesive pearlised paper. It has been found that using a removable label having a base layer of pearlised paper on supports reduces or even substantially eliminates the residue retained on the support once the label is removed, as well as reducing or substantially eliminated any damage caused to the support (such as damage to paint, wallpaper, polished surfaces or the like).

In another embodiment of the invention, the pearlised paper may be provided with a magnetic layer on the first face thereof, such that the label may be removably applied to a suitable magnetic support.

In another embodiment, the base layer may comprise a pearlised paper and a vinyl layer may be overlaid over the top of the pearlised paper. The vinyl layer may overlie only a part of the pearlised paper. The vinyl layer may be used to form names or aesthetically pleasing shapes.

In a further alternative embodiment of the invention, the base layer may comprise a synthetic paper. Preferably, the synthetic paper may be adapted to adhere to a wide variety of surface materials, such as, but not limited to, glass, acrylic, PVC, metal (for instance, steel or aluminium), polypropylene and coated paper. Preferably, the synthetic paper is adapted to adhere to surface material without the use of adhesives, magnets or static electricity. Thus, it is preferred that the composition of the synthetic paper is such that the synthetic paper has physical and/or chemical properties that allow it to adhere to, and be retained on, a surface without the use adhesives or the like.

Preferably, the synthetic paper is removable. In addition, it is preferred that the synthetic paper is reusable to allow the label to be used multiple times and potentially in multiple locations.

A suitable synthetic paper may include Octopus paper manufactured by Yupo Corporation.

In some embodiments of the invention, the base layer may be provided with a pattern, decorative markings or the like. In this embodiment of the invention, it is envisaged that the overlay layer will not extend to the edges of the base layer. Instead, the overlay layer may extend only part-way to the edges of the base layer so that the pattern or decorative markings provided on the base layer may be visible at the edges of the label. Any suitable pattern or decorative markings may be used. For instance, the pattern may be any suitable repeating pattern, or the decorative markings may be provided either to make the label more aesthetically-pleasing, or may be provided to make the label look like another object. For instance, the decorative markings may be provided to give the label the appearance of an animal, vehicle or the like.

The support may be of any suitable type, such as wooden or plastic surfaces (including walls, doors, cupboards, floors etc), enameled surfaces (such as baths or the like), metallic surfaces (such as refrigerator doors or the like), glass surfaces (such as windows), or furnishings (such as carpet, cloth upholstery, leather upholstery, curtains or the like), or any combination thereof.

The label of the present invention may be of any suitable size and shape. For instance, for commercial, corporate or educational purposes, the label may be large enough to cover a substantial portion of, for instance, a wall. In this embodiment, it may be preferable that the label is provided as a regular shape (square or rectangular, perhaps) in order to maximize the available writing space. Alternatively, for decorative purposes, or when being used in, for instance, children's bedrooms or a similar location, the label may be cut to a more aesthetically-pleasing shape and a smaller size. Any suitable geometric shape may be used, and, in addition, the label may be cut to a shape representing another item. For instance, the label could be cut to the shape of an animal, flower, toy, vehicle or the like.

### BRIEF DESCRIPTION OF THE DRAWINGS

An embodiment of the invention will be described with reference to the following drawings in which:

FIG. 1 illustrates a cross-sectional view of a label according to an embodiment of the present invention; and

FIG. 2 illustrates a cross-sectional view of a label according to an alternative embodiment of the invention.

### DETAILED DESCRIPTION OF THE DRAWINGS

It will be appreciated that the drawings have been provided for the purposes of illustrating preferred embodiments of the present invention and that the invention should not be considered to be limited solely to the features as shown in the drawings.

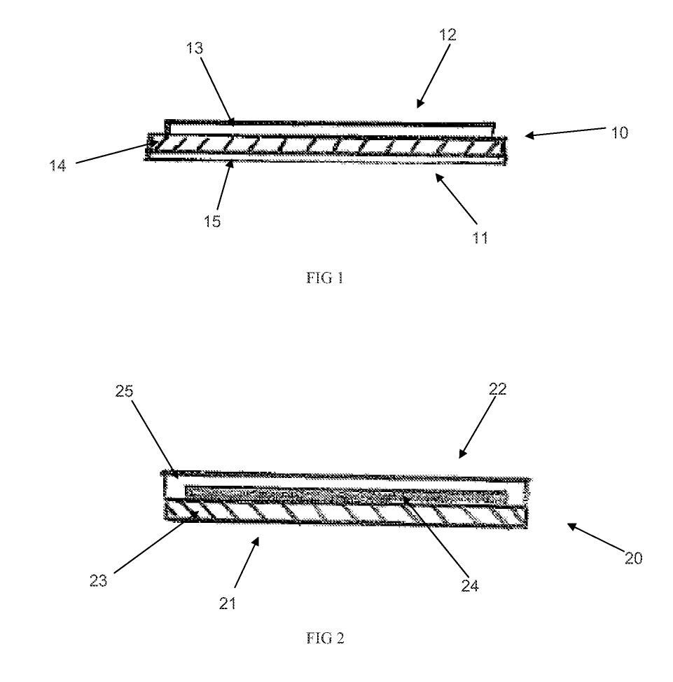

In FIG. 1 there is illustrated a cross-sectional view of a label 10 according to an embodiment of the present invention. In this Figure, the label 10 has a first face 11 adapted for removable attachment to a support (not shown) and a second face 12 having a reusable writing surface 13. In this embodiment of the invention, the reusable writing surface 13 is a layer of whiteboard vinyl laid over (and adhered to) a base layer 14 in the form of a PVC backing.

The first face 11 of the label 10 is provided with an attachment layer 15 in the form of an adhesive layer adapted to assist in attaching the label 10 to a support (not shown).

In FIG. 2 there is illustrated a cross-sectional view of a label 20 according to an alternative embodiment of the invention. In this Figure, the label 20 has a first face 21 adapted for removable attachment to a support (not shown) and a second face 22 having a reusable writing surface 23.

In this embodiment of the invention the label 20 comprises a base layer 23 of pearlised paper, the first face 21 of which is self-adhesive, allowing the label 20 to be removably attached to a support (not shown).

The base layer 23 is provided with an overlay layer 24 laid over a portion of the base layer 23. The overlay layer 24 is a substantially opaque layer printed onto the base later 24 using a suitable technique (for instance, offset printing).

In the embodiment of the invention shown in FIG. 2, the label 20 is provided with an upper layer 25 laid over the overlay layer 24. In FIG. 2, it may be seen that the overlay layer 24 does not extend to the edges of the base layer 23. Thus, the upper layer 25 seals against both the base layer 23 and the overlay layer 24.

The upper layer 25 is formed from a transparent polymer meaning that the opaque overlay layer 24 is visible through the upper layer 25. In this embodiment, while the opaque overlay layer 24 provides the colour contrast that allows writing or drawings on the label 20 to be seen, writing and drawing is actually carried out on the upper layer 25. Thus, the upper layer 25 is formed from a polymer that has properties that allows for writing or drawings to be erased from the upper layer 25 on multiple occasions (so that the label 20 is reusable) without significantly detrimentally affecting the integrity of the upper layer 25.

Those skilled in the art will appreciate that the present invention may be susceptible to variations and modifications other than those specifically described. It will be understood that the present invention encompasses all such variations and modifications that fall within its spirit and scope.

1. A removable label comprising a first face adapted for reversible attachment to a support and a second face comprising a reusable writing surface.

2. A removable label according to claim 1 wherein removal of the label causes minimal or no damage to the support.
